(19) United States
(12) Patent Application Publication
(10) Pub. No.: US 2004/0090984 A1
(43) Pub. Date: May 13, 2004

(54) Network adapter for remote devices

(75) Inventors: Ylian Saint-Hilaire, Hillsboro, OR (US); Jim Edwards, Portland, OR (US)

Correspondence Address: Pillsbury Winthrop LLP, Intellectual Property Group, 725 South Figueroa Street, Los Angeles, CA, 90017-5443, US

(73) Assignee: Intel Corporation, Santa Clara, CA

(21) Appl. No.: 10/292,609

(22) Filed: Nov. 12, 2002

(51) Int. Cl. H04L 12/66

(52) U.S. Cl. 370/463

(57) ABSTRACT

In general, in one aspect, the disclosure describes a network adapter device that can provide a remote host with access to different peripherals connected to the network adapter device. Such peripherals can include, for example, Universal Serial Bus (USB) peripherals and/or consumer electronic peripherals.

### BACKGROUND

In many businesses today, networking has become an integral part of operations. Desktop computers and/or laptops are connected to each other through a business network, such as a local area network (LAN), to enable users within the same company to communicate with each other and to share information. In addition, users within the same company are also able to share and use certain devices, such as printers, through the business network. An Internet connection further compliments the business network to provide access to a vast amount of data. Similarly, setting up a home network has recently become more popular. In a home network, multiple personal computers (PCs) are usually connected to each other through a network connection. Multiple users may, for example, play video games against each other or share a printer or an Internet connection through the home network.

With advancement in computer technology, both hardware-related and software-related, a personal computer (PC) in a home network may have numerous multimedia capabilities, such as playing music and displaying video. With a connection to the Internet, a PC or other computer brings multimedia data and a vast amount of other information to a user. However, even though recent multimedia improvements on the PC have allowed the PC in a home or small network to play music, videos, other types of multimedia and games, the PC has struggled for acceptance in the family room setting. Large consumer electronic (CE) devices, such as a television (TV) and a stereo system, in the family room remain the center of the entertainment experience in most households and small businesses.

### BRIEF DESCRIPTION OF THE DRAWINGS

FIG. 1 is a diagram of a system that includes a network adapter.

FIG. 2 is a schematic of a network adapter.

FIG. 3 is a diagram of a system that includes a network adapter that provides remote access to Universal Serial Bus (USB) devices.

FIG. 4 is a schematic of a universal serial bus (USB) network adapter.

FIG. 5 is a flow-chart of a process to provide remote access to a device.

FIG. 6 is a diagram of a system that includes a network adapter.

FIG. 7 is a schematic of a network adapter.

### DETAILED DESCRIPTION

Reference will now be made to a variety of embodiments, examples of which are illustrated in the accompanying drawings. It will be understood that the invention is not intended to be limited to these sample embodiments. On the contrary, the present invention is intended to cover alternatives, modifications and equivalents, which may be included within the spirit and scope of the invention as defined by the appended claims. In the following detailed description, numerous specific details are set forth in order to provide a thorough understanding. However, the techniques may be practiced without these specific details.

Reference in the specification to “one embodiment” or “an embodiment” means that a particular feature, structure or characteristic described in connection with the embodiment is included in at least one embodiment. Thus, the appearances of the phrase “in one embodiment” or “according to an embodiment” appearing in various places throughout the specification are not necessarily all referring to the same embodiment.

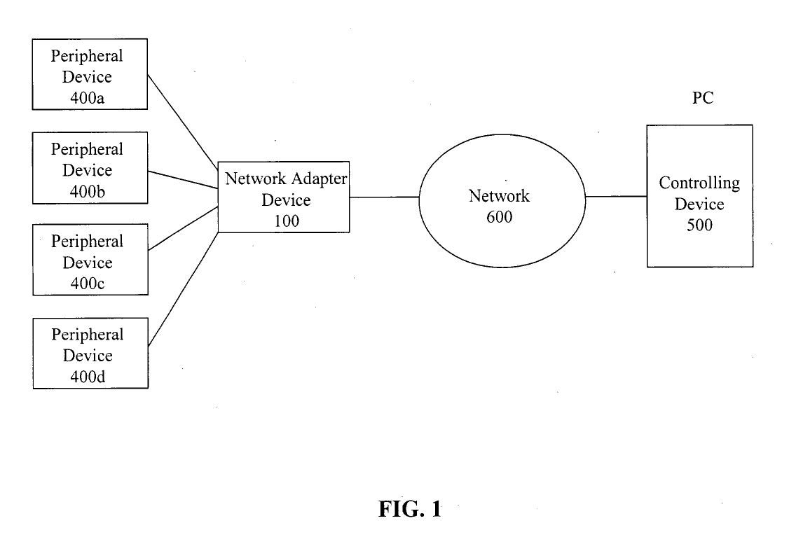

FIG. 1 shows an example of a system that includes a network 600, a controlling device 500, a network adapter device 100 and a number of peripheral devices 400a-400d. The controlling device 500 (e.g., a personal computer (PC)) is connected to the network 600. The network 600 may, for example, be a home network. The network adapter device 100 is also connected to the network 600 and located remotely from the controlling device 500. The peripheral devices 400a-400d are connected to the network adapter device 100. In one embodiment, the controlling device 500 and/or the network 600 is further connected to the Internet (not shown). The connection between a peripheral device 400a-400d and the network adapter device 100, connection between the network adapter device 100 and the network 600, connection between the network 600 and the controlling device 500, and connection to the Internet may be through a wire or wireless medium.

In the system, the network adapter 100 provides the controlling device 500 with transparent access to the peripheral devices 400a-400d, despite their remote location from the controlling device 500. While the network adapter 100 acts as an intermediate between the peripherals 400a-400d and the controlling device 500, the controlling device 500 can interact with the peripherals as if they were connected to the device 500 via a local peripheral bus.

In one embodiment, the network adapter device 100 includes logic that supports a discovery protocol, such as Universal Plug and Play (UPnP) (Universal Plug and Play Device Architecture, version 1.0, Jun. 13, 2000, from the Universal Plug and Play Forum), to allow the controlling device 500 to discover the network adapter device 100 over the network 600 without user intervention. Alternately, static configurations may be used.

The peripheral devices 400a-400d may include a wide variety of devices, including consumer electronic (CE) devices in addition to traditional computer peripherals (e.g., storage, printers, and so forth). The controlling device 500 and the peripheral devices 400a-400d can engage in interactive sessions through the network adapter 100 and the network 600. For example, control signals, computer data or multimedia data may be sent to the controlling device 500 by a peripheral device 400a-400d, which in turn may send response data to the peripheral device. Data such as control signals, display signals, and computer instructions, may also be generated by the controlling device 500 and sent to the peripheral device.

Although only one controlling device 500 and one network adapter device 100 are shown in FIG. 1, there may be more than one controlling device and/or more than one network adapter device connected to the network 600. Further, the network adapter 100 may connect to more or fewer peripherals than the four 400a-400d shown.

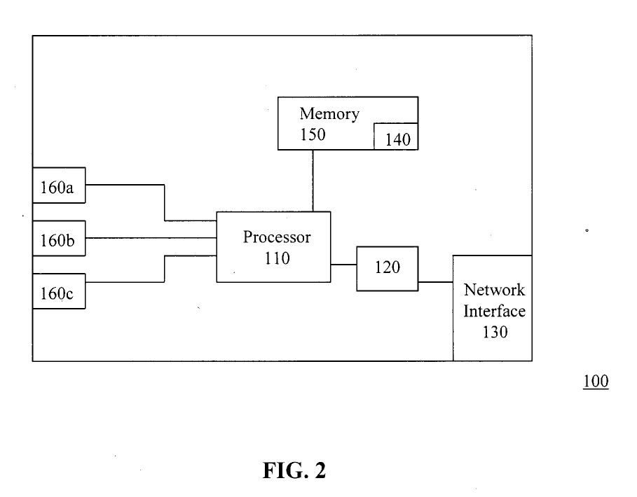

FIG. 2 illustrates an example of a network adapter device. The network adapter device 100 includes a processor 110, a communication stack 120, a network interface 130, logic 140, memory 150 and peripheral device interfaces 160a-160c. The network interface 130 allows the network adapter device 100 to be connected to a network 600, such as a home network. The communication stack 120 facilitates data transfer through the adapter device 100 to the network interface 130. The peripheral device interfaces 160a-160c are adapted to communicate with peripheral devices 400a-400d.

A controlling device 500, at a remote location on the network, interacts with the peripheral devices connected to the peripheral device interfaces 160a-160c via the adapter device 100. The logic 140 (e.g., computer instructions stored in memory 150) handles data received from the controlling device 500 via the network interface 130 and transmission of corresponding data to the correct peripheral devices through the corresponding peripheral device interfaces 160a-160c. Likewise, the logic 140 handles data received from the peripheral devices through the peripheral device interfaces 160a-160c and transmission of corresponding data to the controlling device 500 via the network interface 130.

Data transmitted by a peripheral can include data that facilitates in the recognition of the PC peripheral by the PC (e.g., UPnP data). The data may also be in the form of PC peripheral control information, such as administrative data, as well as data ordinarily sent by the PC peripheral to the PC and data ordinarily received by the PC peripheral from the PC when the PC peripheral is directly connected to the PC by a local bus. The PC peripheral may utilize different communication/connection schemes, such as USB, peripheral component interconnect (PCI), serial, parallel and Institute of Electrical and Electronics Engineers (IEEE) Standard 1394 (IEEE Standard for a High Performance Serial Bus—Firewire, 1995, from the Institute of Electrical and Electronics Engineers).

The network adapter device 100 may be built with peripheral device interfaces 160a-160c capable of receiving PC peripherals with a certain type of communication scheme, such as USB. However, the network adapter device 100 may also be built with the peripheral device interfaces 160a-160c capable of receiving multiple communication schemes.

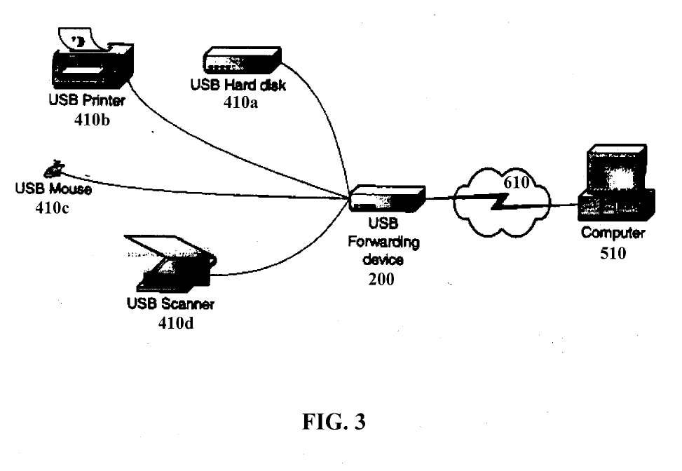

FIG. 3 shows an exemplary system that utilizes a network adapter device in the form of a USB forwarding device 200 in a home network. In this example, peripheral accessories 410a-410d include a USB hard disk 410a, a USB printer 410b, a USB mouse 410c and a USB scanner 410d. In the embodiment, the controlling device is in the form of a computer 510. The computer 510 is connected to the remotely located peripheral accessories 410a-410d through the home network 610 and the USB forwarding device 200. The home network may use a wide variety of wired or wireless schemes including Ethernet (IEEE Standard 802.3-2002, Carrier Sense Multiple Access with Collision Detection (CSMA/CD) Access Method and Physical Layer Specifications, 2002, from the Institute of Electrical and Electronics Engineers), Home Phoneline Networking Alliance (HomePNA) (HomePNA Specification 3.0, 2002, from the Home Phoneline Networking Alliance), Home Radio Frequency (HomeRF) (HomeRF 2.0 Specification, 2002, from the Home Radio Frequency Working Group, Inc.), IEEE Standard 802.11b (Higher-Speed Physical Layer Extension in the 2.4 GHz Band, 1999, from the Institute of Electrical and Electronics Engineers), IEEE Standard 802.11a (A Very-High-Speed, Highly Scalable Wireless LAN Standard, 1997, from the Institute of Electrical and Electronics Engineers), and IEEE 1394 Firewire. While only one USB forwarding device 200 is shown in FIG. 3, a number of USB forwarding devices may be connected to the home network 610.

As shown, the USB forwarding device 200 can communicate with the controlling device 510 via the home network. The USB forwarding device 200 has the ability to forward USB device connection and control information over the home network 610 to the computer 510, and vice-versa. This data includes information that facilitates in the recognition of the USB accessories 410a-410d by the computer 510 over the network 610, information ordinarily sent by the USB accessories 410a-410d to the computer 510 and ordinarily received by the USB accessories 410a-410d from the computer 510 when the USB accessories 410a-410d are connected to the PC 510 by a local USB bus, and administrative information sent between the computer 510 and the USB forwarding device 200. The administrative information may be, for example, data such as the number of USB host interfaces of USB forwarding device 200, whether the forwarding device 200 is being used by other controlling devices 510, and so forth.

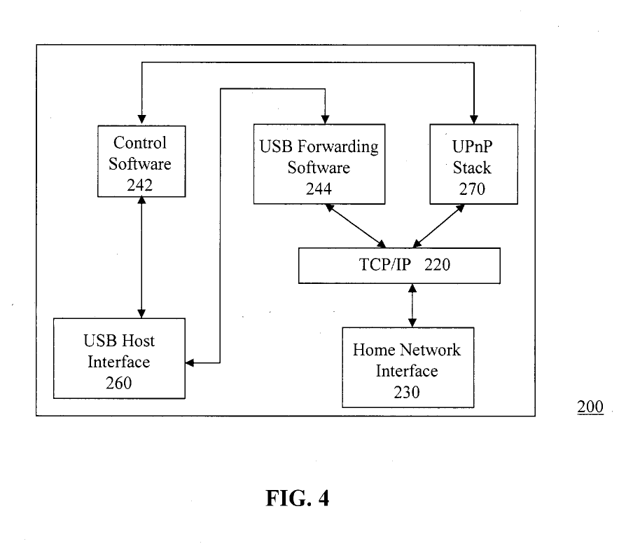

FIG. 4 shows an example of a USB network adapter device. The device 200 includes at least one USB host interface 260, control software 242, USB forwarding software 244, UPnP stack 270, Transmission Control Protocol/Internet Protocol (TCP/IP) stack 220, and home network interface 230. The USB host interface 260 allows data to be transmitted between a USB peripheral accessory and the USB forwarding device 200. Because USB is not a peer-to-peer bus like Ethernet or IEEE 1394, there is a master and a slave. In this case, the USB forwarding device 200 acts as a master, with the USB host interface 260 behaving much like a USB port on a regular PC. The USB forwarding device 200 may have the ability to reject connection of new USB peripheral accessories onto the USB host interface 260, for example, due to power or device limitations.

In operation, data is received by the USB host interface 260 from a USB peripheral accessory. The USB forwarding device 200 facilitates the computer 510 in recognizing the USB peripheral accessory, for example, by forwarding UPnP data for the peripheral. The device 200 also keeps track of where the peripheral data should be forwarded. For example, the device may store the Internet protocol (IP) address of the controlling device 510. Depending on the type of data being generated by the USB peripheral, the data may be processed with the control software 242 or the USB forwarding software 244. In one embodiment, the USB forwarding software 244 is in the form of a USB bridge driver layer, which understands USB commands and allows forwarding of the USB commands to the computer 510 through the home network 610. For example, the USB forwarding device 200 may encapsulate USB data within one or more TCP/IP packets for transmission to the controlling device 510.

While the USB forwarding device 200 can transmit USB data blocks to the controlling device, USB forwarding software 244 may perform some operations and respond to some peripheral requests and messages without forwarding such data to the computer 510. For example, USB is often used to distribute power to USB peripheral accessories. Thus, the USB forwarding software 244, or other software in the USB forwarding device 200, may control power monitoring and management without forwarding this information to the computer 510.

In preparing to forward data, the TCP/IP stack 220 receives the data to be sent to the controlling device 510 and assembles smaller packets to be transmitted over the home network 610. The TCP/IP stack 220 addresses each packet so that it gets to the controlling device 510. If TCP is used, the USB forwarding device 200 delimits the individual USB data payloads in most instances. In other embodiments, other network protocols may be used, including Novell Internetwork Packet Exchange (IPX) and Apple AppleTalk. The packets are then sent to the home network interface 230 en route to the computer 510. Examples of the home network interface 230 include interfaces for Ethernet with speeds of 10/100/1000 Mps, IEEE 1394 Firewire, IEEE 802.11a or IEEE 802.11b wireless, HomePNA, HomeRF, HomePlug (HomePlug Power Appliance Specification 1.0, 2001, from the HomePlug Power Alliance). The computer's 510 TCP/IP stack can reassemble the forwarded data. After extracting the USB data block from the packets, the computer 510 can process the USB data using its USB device driver stack, or USB software stack.

Potentially, there may be numerous USB forwarding devices and other types of network adapter devices connected to the network 610, or there may be numerous computers connected to the network 610. Thus, to correctly route information between the computers and peripherals, the forwarding device 200 may track which peripherals are being used by which controlling devices 510. Because the computer 510 may control a number of USB forwarding devices as well as other types of network adapter devices, it may receive many USB data blocks from many USB forwarding devices, or many data blocks from other types of network adapter devices at any given moment. Thus, the computer 510 keeps track of what data came from which network adapter device.

In instances where multiple USB forwarding devices and multiple PCs are present on a home network, arbitration protocols may be used to determine which PC is granted access to a given remote network adapter device. For example, if a second PC tries to connect to a network adapter device that is already connected to another PC, the connection may be refused. This situation may also be more complex where, for example, the user may configure a device to accept only connections from a single PC in the home. Access may be resolved in several ways. A user may configure access on each PC via a graphic user interface. A user may base access on predefined PC priorities, in which a configuration application is utilized to set a network adapter device to a “first come, first serve” basis or set to a specific PC. If UPnP security is developed in the future, access control mechanisms may be used to ensure the right PC gets access to the devices. A network adapter device, such as a USB forwarding device, may also be configured to respond to a given PC by configuration of a shared token. If the network adapter device does not use UPnP, either the network adapter device or a PC with a forwarding driver is statically configured for access.

For data flowing to a peripheral, the computer 510 encapsulates the USB data in packets addressed to the forwarding device 200 and sends the packets to the home network 610 through the computer's home network interface. Through the home network 610, the data reaches the home network interface 230 of the USB forwarding device 200. The forwarding device's 200 TCP/IP stack 220 de-encapsulates the USB data and forwards the data to the appropriate peripheral accessory through its USB host interface 260.

The USB forwarding device 200 may be automatically detectable by the computer 510 through the home network 610. The USB forwarding device 200 may, for example, use a standardized UPnP device class profile, enabling it to report itself as a UPnP device on the home network 610. In a similar fashion, a USB peripheral accessory may also have the UPnP capability. In one embodiment, the UPnP stack 270, in conjunction with the control software 242, serves such purpose. Thus, if the data generated by the USB peripheral accessory is one of the data related to discovery of the peripheral, the data is sent to the controlling software 242. The data is then processed and sent to the UPnP stack 270. Through the TCP/IP stack 220, the home network interface 230 and the home network 610, the data arrives at the computer 510.

Based on the data received at the computer 510, the operating system, or alternative software, the computer 510 is able to detect the presence of the USB forwarding device 200 on the home network 610 and/or the peripherals connected to the USB forwarding device 200. The operating system, or the alternative software, then loads the appropriate device driver for the detected USB forwarding device 200 and/or the PC peripherals. In one embodiment, the driver may be a UPnP forwarding driver, built to talk to the specific USB forwarding device 200 and/or the peripheral. The driver initiates a connection to the USB forwarding device 200 and wedges into the operating system's USB device driver stack to enable forwarding of USB messages. A remotely attached USB peripheral accessory is enumerated, making it appear as if it was connected to the computer 510 via a local USB bus. This configuration minimizes the need for user configuration and allows the computer 510 to automatically detect the USB forwarding device 200 and/or the PC accessories connected to the USB forwarding device 200 without user intervention. It is noted that some USB forwarding devices may not utilize UPnP or other similar discovery protocol. In such case, the UPnP stack 270 may be eliminated, and either the USB forwarding device 200 and/or the computer 510 with the forwarding driver may be statically configured for access.

The computer 510 may include software to look at the performance characteristics or network conditions of the home network and allow forwarding only to a few devices. For example, a driver for the forwarding device may evaluate bandwidth, latency or jitter, which may change over time depending on what other network nodes are doing and depending on the degree of interference if a wireless medium is used. The driver may also use a Quality of Service (QoS) mechanism provided by the home network to facilitate high quality connections to remotely attached USB devices. For example, QoS may be used to guarantee delivery of real time audio traffic from a PC to a USB speaker attached to the networked USB forwarding device 200.

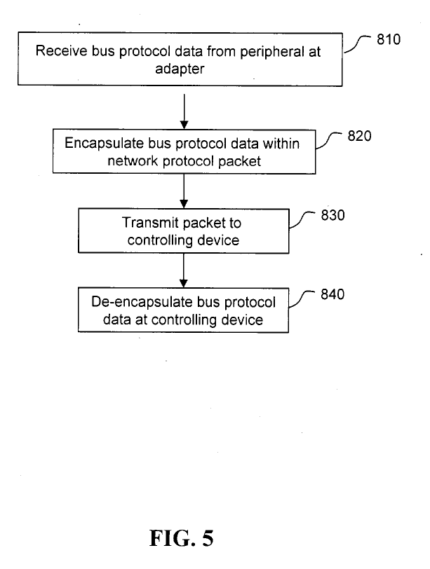

FIG. 5 illustrates a process for sending peripheral data through the network adapter to a controlling device. As shown, the adapter receives 810 the peripheral data (e.g., a USB data block) and encapsulates 820 the data within one or more packets. The adapter sends 830 these packets to the controlling device which subsequently de-encapsulates 840 and processes the USB data.

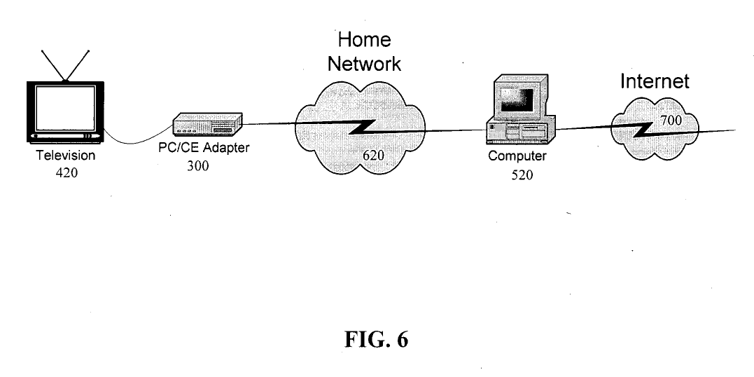

FIG. 6 shows an example of a system that uses a network adapter to permit a computer, such as a home PC, to provide a wide range of experiences to, the family room without having to move the PC to the family room location. The system shown includes a TV 420, a personal computer/consumer electronic (PC/CE) network adapter device 300, a home network 620, a controlling device in the form of a computer 520, and the Internet 700. The PC/CE network adapter device 300 communicates on the home network 620. The home network 620 may, for example, be any of the many wired or wireless mediums available, including Ethernet, HomePNA, HomeRF, IEEE 802.11b, IEEE 802.11a, IEEE 1394 Firewire, etc.

Through the home network 620, the computer 520 is able to communicate with CE devices (e.g., the TV 420) via a PC/CE network adapter device 300. Thus, the PC/CE network adapter device 300 can bring many capabilities of the computer 520 to a family room CE device, such as a TV 420 and a stereo system. The connection to the Internet 700 provides increased information and entertainment capabilities, which may be explored by using a CE device virtually anywhere in the home. While FIG. 6 depicts a personal computer, the controlling device may take other forms. For example, a residential gateway or a dedicated media server may act as a host for family room applications. The residential gateway, for example, connects DSL or cable to the home network and acts as a firewall while the media sever includes a set top box (STB) that provides service such as video-on-demand or personal video recording capability via the adapter 300.

A wide variety of information may be transmitted between the PC/CE network adapter device 300 and the hosting computer 520 through the home network 620. The data generally relates to, among others, CE connection information, CE remote display information, CE remote synchronization information and CE remote input command information. For example, the PC/CE network adapter device 300 may receive interactive data in the form of control commands and/or display commands—e.g., clear, draw line, circle, text, picture, movie—from the hosting computer 520 on the home network 620 and render these commands to the TV 420. In one embodiment, pictures are displayed on a picture frame device to create a simple user interface and simple images/animations. To accomplish this feature, a basic set of primitives may, for example, be used. Primitives that may be used include one that resets the TV 420, supports double buffering, draws a fill box, draws an image, places a streaming video at a designated location, and repaints/updates the screen.

The PC/CE network adapter device 300 may also forward remote control or input commands over the home network 620 to the hosting computer 520. The host 520 can then send corresponding control signals to the target of the input. Depending on the type of CE devices being controlled, different interactive data are transferred between the CE device and the hosting computer 520. For example, if a stereo system is the CE device, then interactive data in the form of audio data, along with display and/or operation commands, may also be transmitted to and from the hosting computer 520. In addition to the TV 420 and the stereo system, a video player device, other audio player device, a recording device, other video display device, an intelligent appliance, a communication device or a wireless device may be connected to the PC/CE network adapter device 300.

The hosting computer 520 may run software that supports remote control or input commands, as well as other interactive data, from the PC/CE network adapter device 300. The hosting computer 520 further runs software that provides control and/or display commands to the remote CE device. For example, when user input or remote control commands are sent to the hosting computer 520, the computer 520 interprets the user remote control or input commands and forwards the information to the designated computer hosted device application. The hosting computer 520 may, for example, support a programming model for applications that provide specific family room experiences for the remote CE device. In one embodiment, this supporting software on the hosting computer 520 runs in a background mode so that it will not disturb a user currently using the hosting computer 520, other than possibly using spare processing power, storage space, etc. Depending on different environments, one or many PC/CE network adapter devices and one or many computers may be installed in the home/business simultaneously, with all of them connected together via the home network 620. In one embodiment, a user is allowed to optionally configure which computer connects to which adapter. The supporting software ensures that the PC/CE network adapter devices are used in a coordinated fashion. The maximum number of PC/CE network adapter devices may, for example, be limited by the available computer resources and network bandwidth.

Preferably, the supporting software on the hosting computer 520 is expandable and/or able to be upgraded, providing a plug-in model for adding new services that are installed either locally or over the Internet. The supporting software on the hosting computer 520 that provides the user experience may also leverage any of its other local content and software. For example, Web page filtering, local mail, picture and video storage may be leveraged to provide an even more rich experience. In one embodiment, the supporting software on the hosting computer 520 is remotely managed by a service provider on the Internet. This configuration enables new service-based business models and hides the complexity of setting up and operating the system. Such a model can support subscription or usage-based services. The protocols used to remotely manage software may vary. One example is to use Universal Description, Discovery and Integration (UDDI), which lists available services registered within the UDDI repositories and allows a company that wishes to create a custom solution using Web services to bind several Web services residing in a distributed environment. In operation, a user may select on his/her TV screen new services that he/she wants, and protocols such as UDDI ensures that the service arrives in the home.

Through a combination of the hosting computer 520 and the PC/CE network adapter device 300, a number of rich experiences may be provided to consumers in a family room setting. Examples include using a TV or other CE device to browse the Internet to obtain information, playing media content such as audio and video content distributed from the Internet and cached on the hosting computer 520 or elsewhere on the home network 620, and playing traditional media content from peripherals directly attached to the hosting computer 520, such as a digital versatile disc (DVD) and/or a compact disc read-only memory (CD-ROM) drive/device. Other exemplary experiences include viewing still images from photo albums stored on the hosting computer 520 or elsewhere on the home network, and sharing or reviewing e-mail, pictures, TV show recommendations and ratings, etc. Scenarios that use or display Internet content on the TV 420 via the PC/CE network adapter device 300 not only leverage the hosting computer's browsing and decoding capabilities, but also use the computer 520 as a firewall to protect networked devices inside the home from unauthorized access.

The hosting computer 520 may also provide personal video recorder (PVR) capabilities, similar to those provided by Replay and TiVO™. For example, the PC/CE network adapter device 300 provides a digitized video stream that is cached/stored on the hosting computer 520, and the hosting computer 520 in turn provides a time delayed video stream playback and implements the normal PVR capabilities. PVR capabilities also include pausing live TV and offering on-screen TV guides, as well as other TV related services. Interactive TV capabilities may also be provided, with the hosting computer 520, for example, providing content that is roughly synchronized to TV shows and collects input that is used to drive the resulting interactive experience. Furthermore, the hosting computer and PC/CE network adapter device combination may allow the display of an integrated interface that allows a user to select and view home automation, control and security settings and status.

In the embodiment where the CE device is the TV 420, the experiences delivered by the hosting computer 520 may be optimized for the TV environment, such has having large fonts, colors that display well, nice visuals, and a simple menu system suitable for remote control operation. Thus, the experiences hosted on the computer 520 are adaptive to scale to the available capabilities of the home network 620. In addition, depending on the devices connected on the home network 620 and to the hosting computer 520, user experiences like PVR and home automation may or may not be available. It is noted that the hosting computer 520 adjusts accordingly in terms of the experiences that are given to the user.

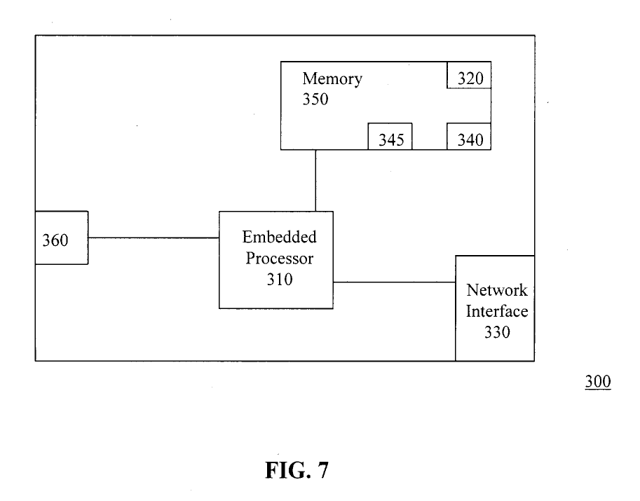

FIG. 7 shows an example of a PC/CE network adapter device. The PC/CE network adapter device 300 includes an embedded processor 310, a UPnP stack 320, a network interface 330, display remoting software 340, input remoting software 345, memory 350, and a peripheral device interface in the form of a display output connector 360. The network interface 330 allows the PC/CE network adapter device 300 to be connected to a network, such as a home network. The display remoting software 340 and the input remoting software facilitate data transfer through the PC/CE network adapter device 300 to the network interface 330. The peripheral device interface 360 is adapted to receive a CE device, such as a TV or a stereo system. In one embodiment, graphics processing for graphics display at the CE devices may also be integrated on the PC/CE network adapter device 300.

A computer, sitting at a remote location on the home network, interacts with the CE device via the PC/CE network adapter device 300. The display remoting software 340 may use content and services on the Internet, the local hard drive and/or other PCs connected to the home network to generate a rich user interface. This user interface is then sent to the PC/CE network adapter device, which then displays it on a CE, such as a TV. Small video and animations may also be synchronized for display. If audio is desired, instead of or in conjunction with a video display, audio remoting software is further included. The input remoting software sends users input commands to the computer for processing. It is noted that the software in the memory 350 changes according to the different CE devices connected to the PC/CE network adapter device 300. Because the computer provides many required resources—e.g., processing, storage, flexibility—and the intelligence to manage the CE devices in the home, the PC/CE network adapter device may be made with low cost and simple setup in mind.

A CE device may utilize a different communication/connection scheme to communicate with the PC/CE network adapter device 300. Depending on the type of CE device to be connected, the PC/CE network adapter device 300 may provide different peripheral device interfaces to common CE devices using current analog connector connections or digital connector connections. For example, analog connector connections include RCA audio and video connector connections while digital connector connections include USB, serial, parallel, IEEE 1394 Firewire, and Sony/Philips Digital Interface (S/PDIF) connections.

The UPnP stack 320 allows automatic detection of the PC/CE network adapter device 300, making itself discoverable as a service on the home network without user intervention. In one embodiment, the PC/CE network adapter device 300 further includes a UPnP audio/video stack as well as audio and video encoders and decoders. This configuration may be implemented by software stored in the memory 350, or by the hardware equivalent. The PC/CE network adapter device 300 may also include home automation switching capabilities, with action commands being sent from the computer to the PC/CE network adapter device 300.

A wide variety of techniques may be used to support PC discovery of a device connected to the adapter 300. For example, after detecting a connected device, the network adapter 300 can transmit device identification or other characteristics (e.g., display size, image encoding type, input mechanism) to the PC. This information may be provided by the connected device and/or as data accessed by the PC upon receipt of information identifying the device. The PC then adapts itself to the target, for example, by selecting appropriately sized fonts, screen layout, or audio menus.

To fully extend experiences hosted by a computer in a preferred embodiment, the PC/CE network adapter device 300 may also include remote control and local input interfaces. Examples of the interfaces include Infrared (IR), Radio Frequency (RF), Bluetooth (Bluetooth Specification, version 1.1, 2001, from the Bluetooth Special Interest Group), and USB. At a given time, one or more of these interfaces are used to send remote control and input information to the hosting computer for family room experiences. At the hosting computer, the remote control and input information are processed and later utilized to drive user interfaces shown on a TV. In an embodiment where an infrared (IR) interface is supported, the PC/CE network adapter device 300 may be placed on top of the TV and within range of the infrared remote control.

According to an embodiment of the present invention, the PC/CE functionality as provided by the PC/CE network adapter device 300 is achieved by placing supporting software, including display remoting software and input remoting software, and/or supporting hardware on devices such as a network-enabled game console, Set-Top Box (STB), DVD, TV, or PVR. The STB may, for example, be a WebTV™, Ultimate TV, Tivo™, or Replay.

In situations where there is more than one PC/CE network adapter device located in a home or a business, a single remote control can operate them by interacting with the hosting computer to provide the needed coordination. In one embodiment, a wireless remote control is used, and the user may assign a room name for each PC/CE network adapter device to a specific button on the remote control, so that he/she can control the operation of any PC/CE network adapter device from anywhere in the house. The remote control may also be equipped with a small, low cost screen for instant feedback to a user. This onboard screen may allow the user to select songs from a play list, or play an interactive family game where hidden choices are required, such as in a poker game. In one implementation, the screen is driven by applications running on the hosting computer.

In a more advanced version/embodiment of the PC/CE network adapter device, an IR out connector is built in the PC/CE network adapter device. This feature allows the PC/CE network adapter device to operate the TV and other family room equipment just as if the user were using a conventional remote control in the family room. In another embodiment, the PC/CE network adapter device is also equipped with appropriate audio/video input connectors to allow it to accept audio/video sources and digitize the media. The PC/CE network adapter device then sends the digitized media out over the home network to the hosting computer or to any other networked PC/CE network adapter device and the CE device connected thereto. The routing and control of these streams are coordinated and controlled by the hosting computer. For example, a user can use two PC/CE network adapter devices to operate the basement videocassette recorder (VCR) remotely from the family room using a computer-hosted family room user interface. In another scenario, the user selects a song from a play list displayed on the remote control screen, the computer hosted software instructs another PC/CE network adapter device to start a CD-ROM reader which then streams audio over the home network to the PC/CE network adapter device connected to the stereo system closest to the user.

Although many of the aforementioned embodiments of the present invention are shown to apply and/or described as being applied to a home network, they are not limited to the home environment. Small offices or any other location with wiring/space constraints may use embodiments of the present invention to connect a PC peripheral to a PC over a LAN. In specific embodiments relating to forwarding devices, it is noted that USB is also a power distribution network. The USB forwarding device, or other similar power distribution capable device, is self-powered or powered with an AC adapter, and in turn provides power to the PC accessories or CE devices attached to the host USB connector. Similarly, some network types also provide a power distribution capability—e.g., power over Ethernet or IEEE 1394 Firewire. If power is available over a given network type, it may be used to power a network adapter device and/or its attached peripheral devices within the limitations of the power source.

Embodiments of the present invention may also be used on a wireless network to make a USB forwarding device, a PC/CE network adapter device, or other types of network adapter devices, wirelessly mobile in a given environment. A wireless network transceiver and the necessary wireless networking layers may be integrated. Any wireless technology that sends IP packets is suitable. In one embodiment, a small wireless forwarding device is attached to a USB PC accessory that is in turn powered by a battery or an alternating current (AC) adapter. Moreover, a forwarding device or a PC/CE network adapter device may be combined with other functionality. For example, embodiments of the present invention may be added to a STB or cable box sitting on top of the TV in the family room, or added to an Internet gateway box.

While the foregoing description refers to particular embodiments of the present invention, it will be understood that the particular embodiments have been presented for purposes of illustration and description. They are not intended to be exhaustive or to limit the invention to the precise forms disclosed. Many modifications and variations are possible in light of the above teachings and may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A network adapter device, comprising:
a processor;
a network interface;
at least one peripheral device interface; and
logic to cause the processor to:
relay data between a peripheral device connected to the network adapter device via one of the least one peripheral device interface and a host accessible via a network accessed via the network interface; and
automatically transmit discovery data for the network adapter to the host.

2. The network adapter device of claim 1, wherein the logic to relay data comprises logic to:
encapsulate data received from the peripheral device in a first packet;
transmit the first packet to the host via the network;
de-encapsulate data included in a second packet received from the host via the network; and
transmit the de-encapsulated data to the peripheral device.

3. The device of claim 1, wherein the peripheral device interface comprises a Universal Serial Bus (USB) interface.

4. The device of claim 1, wherein the peripheral device interface comprises at least one of a Peripheral Component Interconnect (PCI) bus interface, a Firewire bus interface, and a Sony/Philips Digital Interface (S/PDIF) interface.

5. The device of claim 1, wherein the logic to automatically transmit discovery data comprises logic for Universal Plug and Play (UPnP).

6. A method of providing access to a computer peripheral, the method comprising:
receiving, at a device connected to a network, a first block of Universal Serial Bus (USB) data from a locally connected USB peripheral;
encapsulating the first block of USB data within a first set of at least one Transport Control Protocol/Internet Protocol (TCP/IP) packet; and
transmitting the first set of at least one TCP/IP packet encapsulating the first block of USB data from the networked device to a remote device over a network.

7. The method of claim 6, further comprising:
receiving the first set of at least one TCP/IP packet at the remote device;
de-encapsulating the first block of USB data from the at least one TCP/IP packet; and
processing the USB data at the remote device using a USB stack.

8. The method of claim 6, further comprising providing Universal Plug and Play (UPnP) discovery logic at the networked device.

9. The method of claim 6, further comprising receiving Universal Plug and Play (UPnP) data from the peripheral at the networked device.

10. The method of claim 6, further comprising receiving Universal Plug and Play (UPnP) data from the peripheral at the remote device.

11. The method of claim 6, further comprising:
receiving a second set of at least one TCP/IP packet from the remote device at the networked device;
de-encapsulating a second block of USB data from the second set of at least one TCP/IP packet; and
transmitting USB data to the peripheral from the networked device.

12. A network adapter device, comprising:
a processor;
a network interface;
at least one interface to a consumer electronics device; and
logic to cause the processor to:
determine one or more characteristics of an attached consumer electronics device; and
transmit the one or more characteristics to a host located on a network via the network interface.

13. The device of claim 12, wherein the interface to the consumer electronics device comprises at least one of a Universal Serial Bus (USB) interface, Firewire interface, and a Sony/Philips Digital Interface (S/PDIF).

14. The device of claim 12, wherein the interface to the consumer electronics device comprises an interface to connect to at least one of a television and a stereo.

15. The device of claim 12, wherein the one or more characteristics comprise an identification of the attached consumer electronics device.

16. The device of claim 12, wherein the one or more characteristics comprises at least one user interface characteristic.

17. The device of claim 16, wherein the user interface characteristic comprises at least one of a screen dimension and an input mechanism provided by the consumer electronics device.

18. The device of claim 12, further comprising an interface to receive data from a user.

19. The device of claim 18, wherein the interface to receive data from the user comprises an interface to receive information from a remote control.

20. The device of claim 19, wherein the logic comprises logic to relay information received from the remote control to the host via the network interface.

21. A method, comprising:
determining one or more characteristics of a consumer electronics device attached to a network adapter via an consumer electronics interface;
transmitting the one or more characteristics to a host located on a network via a network interface;
generating user interface data based on the one or more characteristics; and
transmitting the user interface data to the consumer electronics device.

22. The method of claim 21, wherein the consumer electronics interface comprises at least one of a Universal Serial Bus (USB) interface, Firewire interface, and a Sony/Philips Digital Interface (S/PDIF).

23. The method of claim 21, wherein the consumer electronics device comprises at least one of a television and a stereo.

24. The method of claim 21, wherein the one or more characteristics comprise an identification of the attached consumer electronics device.

25. The method of claim 21, wherein the one or more characteristics comprise at least one user interface characteristic.

26. The method of claim 25, wherein the user interface characteristics comprise at least one of a screen dimension and an input mechanism provided by the consumer electronics device.

27. The method of claim 21, further comprising:
receiving data from a remote control; and
transmitting the receive data to the host.

28. The method of claim 21, wherein the user interface data comprises display graphics.

29. A computer program product, disposed on a computer readable medium, for providing access to a computer peripheral, the program including instructions for causing a processor to:
receive a first block of Universal Serial Bus (USB) data from a locally connected USB peripheral;
encapsulate the first block of USB data within a first set of at least one Transport Control Protocol/Internet Protocol (TCP/IP) packet; and
transmit the first set of at least one TCP/IP packet encapsulating the first block of USB data from the networked device to a remote device over a network.

30. The program of claim 29, further comprising instructions for causing the processor to:
receive a second set of at least one TCP/IP packet from the remote device;
de-encapsulate a second block of USB data form the second set of at least one TCP/IP packet; and
transmit USB data to the locally connected USB peripheral from the networked device.
